(19) United States
(12) Patent Application Publication
(10) Pub. No.: US 2015/0302419 A1
(43) Pub. Date: Oct. 22, 2015

(54) APPRAISAL ADJUSTMENTS SCORING SYSTEM AND METHOD

(71) Applicant: Fannie Mae, Washington, DC (US)

(72) Inventors: Paul Obrecht, Santa Fe, NM (US); Adam Davis, Alexandria, VA (US); Alex Medinets, Washington, DC (US); Eric Rosenblatt, Derwood, MD (US); Zachary Dawson, Washington, DC (US)

(73) Assignee: FANNIE MAE, Washington, DC (US)

(21) Appl. No.: 14/258,512

(22) Filed: Apr. 22, 2014

(51) Int. Cl. G06Q 30/00; G06Q 50/16; G06Q 30/02

(52) U.S. Cl. CPC G06Q 30/018; G06Q 30/0278; G06Q 50/16

(57) ABSTRACT

A system and method for appraisal adjustments scoring rates the quality of adjustments made by appraisers in their appraisals of real property. This is done by accessing a model adjustment database that is based on an automated valuation model and a peer adjustment database that is based on an aggregate of appraiser peers in the same geographic location as the subject property. A comparison is conducted for adjustments made by the appraiser to both model adjustments and peer adjustments to determine discrepancies. When a discrepancy is larger than a threshold, a message or warning may be generated. A sales pool composition database is also accessed to determine a valuation impact of the flagged adjustments given the particular set of comparable sales selected by the appraiser. After data evaluation, a rating score is calculated for the property appraisal based on the number and severity of messages and the valuation impact.

### BACKGROUND

1. Field of the Invention

This application relates generally to computer implemented analysis of price appraisal data. More specifically, the application relates to a system and method for performing computer implemented analysis and scoring of real estate appraisal adjustment data.

2. Description of the Related Art

The sales comparison approach is the primary valuation method used for most residential appraisals in the United States. This approach is based on the assumption that home purchasers will pay no more for a property than it would cost to purchase a comparable substitute property. Because it is rare to find two identical houses for sale at the same time in the same neighborhood, appraisers typically select comparable sales (“comps”) that vary from the subject property on a variety of factors, and then account for the differences using a formal adjustment process. The resulting opinion of subject property market value should represent the appraiser's professional conclusion, based on market data, logical analysis, and judgment.

First, the appraiser documents facts about the subject property and obtains facts about the recent sales of other properties in the local market. From these facts, the appraiser identifies the comps by determining which property characteristics drive value in the subject property's market and selecting the properties that are most similar to the subject property in these respects. In addition to physical property characteristics, recency of sale and geographical proximity are key factors in determining similarity.

Next, the appraiser calculates dollar-value adjustments for differences in property characteristics between each comp and the subject. For each feature where the comp is inferior to the subject property, the appraiser adds value to the sale price of the comp. For each feature where the comp is superior, the appraiser subtracts value. The end result of all adjustments should equal the market value of the subject property. The appraiser then reconciles the adjusted value of the various comps and calculates the appraisal value of the subject property by determining an appropriate weighted average for the values of the adjusted comps.

Many appraisers, however, tend to under-adjust in their appraisals. Specifically, appraisers routinely select as comps properties having superior property characteristics but then fail to subtract an appropriate amount for the comps' advantages. Because of this, the practice of comp selection itself leads to adjustments that can artificially inflate the appraised value of a subject property. Furthermore, because appraisers routinely attempt to create the best impression of a subject property, the set of comps that they select and the adjustments that they make can create false and inflated value.

In this manner, when an appraiser is motivated to inflate the value of a subject property, he or she may ignore good comps close to the subject property that have low sale prices. Instead, the appraiser may select comps that are superior to the subject property because, for example, they are of a newer construction, are closer to desired neighborhood amenities, or are located in better school districts. The value of the subject property will then be inflated if the appraiser simply makes smaller-than-warranted downward adjustments to account for the differences.

Accordingly, there is a need for a system and method to rate the quality of the adjustments made by appraisers in their appraisals of real property. Furthermore, there is a need for a system and method for detecting and quantifying adjustment issues found in an appraisal.

### SUMMARY

In one example, this application describes a system and method of evaluating risk in the adjustment of the comps in real estate appraisals. Using algorithmic modeling, various embodiments evaluate an appraiser's claims against industry standards, model predictions, and geographic information service (GIS) analysis, etc. Various embodiments detect erroneous adjustments because they are both materially different from a model estimate and materially different than those made by the majority of appraisers in the same area.

According to one embodiment, the scoring of appraisal adjustments rates the quality of adjustments made by appraisers in their appraisals of real property. This is done by accessing a model adjustment database that is based on an automated valuation model and a peer adjustment database that is based on an aggregate measure of appraiser peers in the same geographic location as the subject property. A comparison is conducted for adjustments made by the appraiser to both model adjustments and peer adjustments to determine discrepancies. When a discrepancy is larger than a threshold, a message or warning may be generated. A comparable sales pool composition database is also accessed to determine a valuation impact of the adjustments made on the particular set of comparable sales selected by the appraiser. After data evaluation, an adjustment rating score is calculated for the property appraisal based on the number and severity of messages and the valuation impact.

This application can be embodied in various forms, including business processes, computer-implemented methods, computer program products, computer systems and networks, user interfaces, application programming interfaces, and the like. The foregoing summary is intended solely to give a general idea of various aspects of this application, and does not limit the scope of the application in any way.

### BRIEF DESCRIPTION OF THE DRAWINGS

These and other more detailed and specific features of various embodiments are more fully disclosed in the following description, reference being had to the accompanying drawings, in which:

FIG. 1 is an example of a property appraisal form for use with various embodiments.

FIG. 2 is an example of a model adjustment data table for use with various embodiments.

FIG. 3 is a graph illustrating an exemplary property characteristic according to the data table of FIG. 2.

FIG. 4 is an example of a peer adjustment data table for use with various embodiments.

FIG. 5 is a graph illustrating an exemplary peer adjustment distribution according to the data table of FIG. 4.

FIG. 6 is a flowchart illustrating an exemplary process of analyzing a subject appraisal according to various embodiments.

FIG. 7 is a flowchart illustrating an exemplary subprocess of analyzing a subject appraisal according to various embodiments.

FIG. 8 is a flowchart illustrating another exemplary subprocess of analyzing a subject appraisal according to various embodiments.

FIG. 9 is an example of a scoring table for use with various embodiments.

FIG. 10A is a block diagram illustrating an exemplary computing device for use with various embodiments.

FIG. 10B is a block diagram illustrating an exemplary appraisal adjustment rating unit for use with various embodiments.

FIG. 11 is a schematic diagram illustrating an exemplary system for use with various embodiments.

FIG. 12 is a schematic diagram illustrating another exemplary system for use with various embodiments.

### DETAILED DESCRIPTION OF THE INVENTION

In the following description, numerous details are set forth, such as flowcharts, data tables, and system configurations. It will be apparent to one skilled in the art that these specific details are merely exemplary and not intended to limit the scope of this application.

Systems and methods are disclosed that provide parties to a real estate transaction with the means to evaluate risk in the adjustments of comparable sales (“comps”) used in real estate appraisals. Although discussed herein in the context of real estate appraisals, it should be understood that the systems and methods herein disclosed are not limited to real estate appraisals, but have application with respect to other types of appraisals and valuation judgments.

[Subject Appraisal Adjustments]

In evaluating a property appraisal, various embodiments may utilize an appraiser adjustment database having entries corresponding to respective property characteristics as determined by an appraiser of a subject property. For example, the database may include entries respectively detailing a property characteristic, a value for the property characteristic corresponding to the subject property, a value for the property characteristic corresponding to the comp, and the value of the adjustment made by the appraiser to account for any discrepancy between the subject property and the comp.

As noted above, as part of the adjustment process, the appraiser must weigh the differences between a subject property and one or more comps. The appraiser chooses comps in a given neighborhood that are most similar to the subject in terms of the characteristics and amenities that drive value in the local market and, for characteristics that are not close or identical, makes appropriate value adjustments to the sale price of the comps to account for the differences.

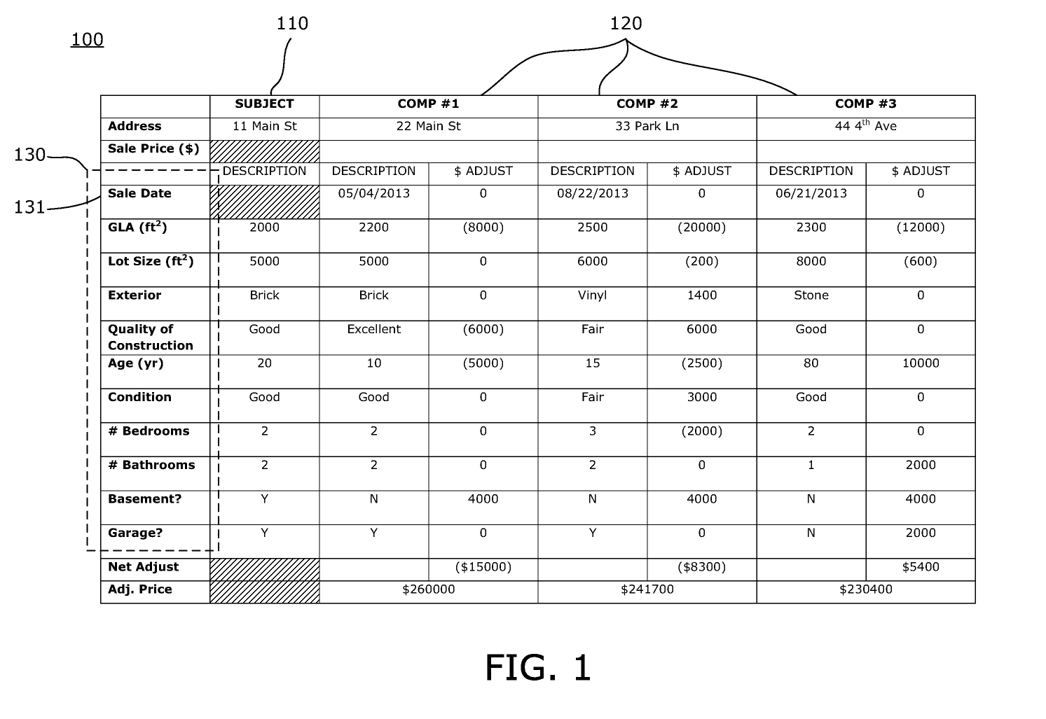

FIG. 1 is an example of a form 100 used to collect appraisal data. Form 100 includes a subject column 110 corresponding to various details of the subject property, as well as a plurality of comp columns 120 corresponding to various details of the comps. Although FIG. 1 shows a form having three comp columns 120, a form may have room for more or fewer comps as desired. Form 100 further includes a plurality of property characteristic rows 130, each row corresponding to a property characteristic 131.

Form 100 may be a paper form that the appraiser fills out by hand or an electronic form that the appraiser fills out electronically.

In the illustrated example, the property characteristics 131 include sale date, gross living area (GLA), lot size, exterior, quality of construction, age, condition, number of bedrooms, number of bathrooms, presence or absence of a basement, and presence or absence of a garage. Form 100 may, however, have more, fewer, or different property characteristics as desired. Although the particular property characteristics 131 shown in FIG. 1 are representative of physical characteristics of the property, various embodiments are not so limited. For example, in other aspects, the property characteristics 131 may be representative of a rental income potential of the property, the cost to build an equivalent property, view from the property, proximity to water or other valued amenities such as a golf course, etc.

Property characteristics 131 may be those found in a Uniform Appraisal Report; for example, proximity to subject, sale price, sale price per GLA, financing concessions, date of sale, location, sale type (i.e., leasehold or fee simple), lot size, view, design (i.e., style), quality of construction, actual age, condition, above grade room count, GLA, finished rooms below grade, functional utility, HVAC, energy efficient items, garage, patio, fireplace, and the like.

For each property characteristic 131, the appraiser enters a value corresponding to the subject property in subject column 110, and values corresponding to the comps in respective comp columns 120. In FIG. 1, a hypothetical subject property has a GLA values of 2,000 ft², and hypothetical comps have respective GLA values of 2,200 ft², 2,500 ft², and 2,300 ft². For each instance where the subject property value differs from a comp, the appraiser enters an adjustment value corresponding to an amount by which the sale price of the comp is adjusted to account for the difference. In FIG. 1, the hypothetical appraiser entered an adjustment to the sale price of Comp #1 downward by $8,000, Comp #2 downward by $20,000, and Comp #3 downward by $12,000. After all relevant property characteristics 131 have been accounted for, the appraiser sums the adjustment values and calculates an adjusted sale price. In FIG. 1, the hypothetical appraiser has adjusted the sale price of Comp #1 downward by $15,000 for an adjusted price of $260,000, Comp #2 downward by $8,300 for an adjusted price of $241,700, and Comp #3 upward by $5,400 for an adjusted price of $230,400. Based on an appropriately weighted average of these adjusted prices, the appraiser calculates an appraised value for the subject property.

The adjustments made by the appraiser on form 100 are preferably in a machine-readable form and the adjustments may be entered into a database. In instances where form 100 is a paper form, the adjustments may be hand coded or electronically coded by a technology such as optical character recognition (OCR). In instances where form 100 is an electronic form, the adjustments may preferably be automatically electronically coded.

[Model Adjustments]

Furthermore, in evaluating a property appraisal, various aspects may utilize a model adjustment database having entries corresponding to expected values of the respective property characteristics as determined by an automated valuation model.

Statistical analysis is performed on housing data to determine the marginal values of particular property characteristics. The results of the statistical analysis (which may be the estimated coefficients of a regression-based model) are entered and stored in a database for future access. Because the computerized model is based on a statistical analysis, the results will typically be more reliable when a larger amount of input data is included.

The computerized model is preferably a regression model. Most preferably, the regression model is a hedonic regression model. In any event, the computerized model determines an expected market price placed on the individual characteristics of a home. At least some of the individual characteristics may correspond to property characteristics 131 described above with reference to FIG. 1; however, the computerized model may incorporate more or fewer characteristics as desired.

An exemplary computerized model operates using the statistical method of linear regression in a logarithmic scale. In such a method, the expected price may be modeled as:

$$P = {α}_{0} + {\sum }_{i}^{ } {α}_{i} \cdot {log}_{β} ( {x}_{i} ) \qquad ( 1 )$$

where P represents the expected price, α₀ is a constant term, xᵢ represents the value of an individual property characteristic, αᵢ represents a coefficient representative of the weight assigned to the corresponding characteristic, and β represents the base of the logarithm. In a regression model, the coefficients αᵢ are calculated so as to minimize the sum of the squared errors. Here, because the price varies as the log base β of the property characteristic, a concept of diminishing returns may be incorporated. For example, a relative increase of 100 ft² of GLA will have a larger impact on the price of a house with a GLA of 1000 ft² than on the price of a house with a GLA of 5000 ft².

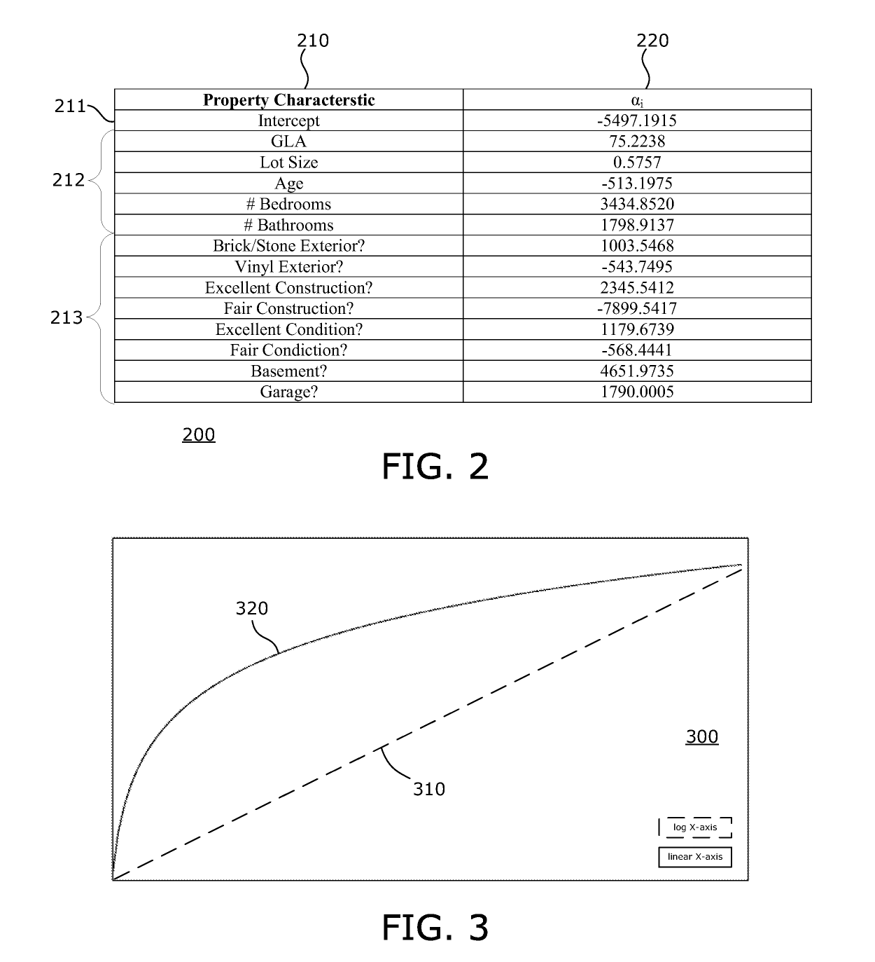

FIG. 2 is an example of a data table 200 for use in a multiple linear regression model in a log scale according to the present disclosure. FIG. 2 includes an identifier column 210 corresponding to various property characteristics and a coefficient column 220 corresponding to coefficients αᵢ. In the data table of FIG. 2, entry 211 corresponds to the constant term α₀, entries 212 correspond to continuous variables, and entries 213 correspond to dummy variables. For purposes of clarity, FIG. 2 only shows a subset of property characteristics for use with various aspects of the present disclosure.

In the illustrated example, the continuous variables are GLA, lot size, age, number of bedrooms, and number of bathrooms. The continuous variables, however, may include any property characteristic capable of being represented as a continuous variable. Furthermore, an automated valuation model may utilize fewer or differently defined continuous variables if desired. In coefficient column 220 corresponding to the continuous variables, a negative number represents a decrease in price with an increase in the value of the corresponding property characteristic, whereas a positive number represents an increase in price with an increase in the value of the corresponding property characteristic.

According to FIG. 2, α_{GLA} is 75.2238 and α_{age} is −513.2238. As such, the expected value of a particular property increases by $75.2238 for each additional order of magnitude (in the same base β as that of the logarithm of equation 1 above) of gross living area and decreases by $513.1975 for each additional order of magnitude of age, for example.

FIG. 3 is a graph 300 illustrating the effect of gross living area on the expected value of the particular property using the model described with regard to FIG. 2. In FIG. 3, the independent variable represents the gross living area of the particular property, whereas the dependent variable represents the value contribution to the expected sale price as a result of the gross living area. Line 310, then, represents the relationship between value and the gross living area in a log scale of the x-axis. To illustrate the concept of diminishing returns described above, line 320 represents the relationship therebetween in a linear scale of the x-axis.

In the illustrated example, the dummy variables are brick/stone exterior, vinyl exterior, excellent construction, fair construction, excellent condition, fair condition, basement, and garage. The dummy variables, however, may include any property characteristic capable of being represented as either 1 or 0. Furthermore, an automated valuation model may utilize fewer or different dummy variables if desired. Of course, because the dummy variables take only one of two possible values, these particular entries may be represented by a linear regression in a linear scale. As such, in coefficient column 220 corresponding to the dummy variables, a negative number represents a decrease in price when the corresponding property characteristic is present, whereas a positive number represents an increase in price with an increase in the value of the corresponding property characteristic.

According to FIG. 2, α_{brick/stone} is 1003.5468 and α_{vinyl} is −543.7495. As such, the expected value of a particular property increases by $1,003.5468 if the exterior is brick or stone and decreases by $543.7495 if the exterior is vinyl siding. If the exterior is neither brick or stone nor vinyl siding, the expected value of the particular property does not increase or decrease.

Although the model adjustments described above have been explained in the context of a linear regression in a log scale, one skilled in the art would recognize that model may be based on a linear regression in log-log scale, a linear regression in a linear scale, a nonlinear regression, combinations thereof, or any other statistical prediction method.

[Peer Adjustments]

Furthermore, in evaluating a property appraisal, various aspects may utilize a peer adjustment database having entries corresponding to aggregate values of respective property characteristics as determined by appraiser peers in the same geographic location as the subject property.

Preferably, a large number of appraisal forms of the type described with reference to FIG. 1 are loaded into a database. The appraisal forms correspond to peer appraisers working in a particular geographical area and in a particular time frame. Thereafter, various aspects calculate a statistical distribution of the magnitude of the adjustments that peer appraisers have made for individual characteristics of a home. At least some of the individual characteristics may correspond to property characteristics 131 described above with reference to FIG. 1; however, the peer adjustment database may incorporate more or fewer characteristics as desired.

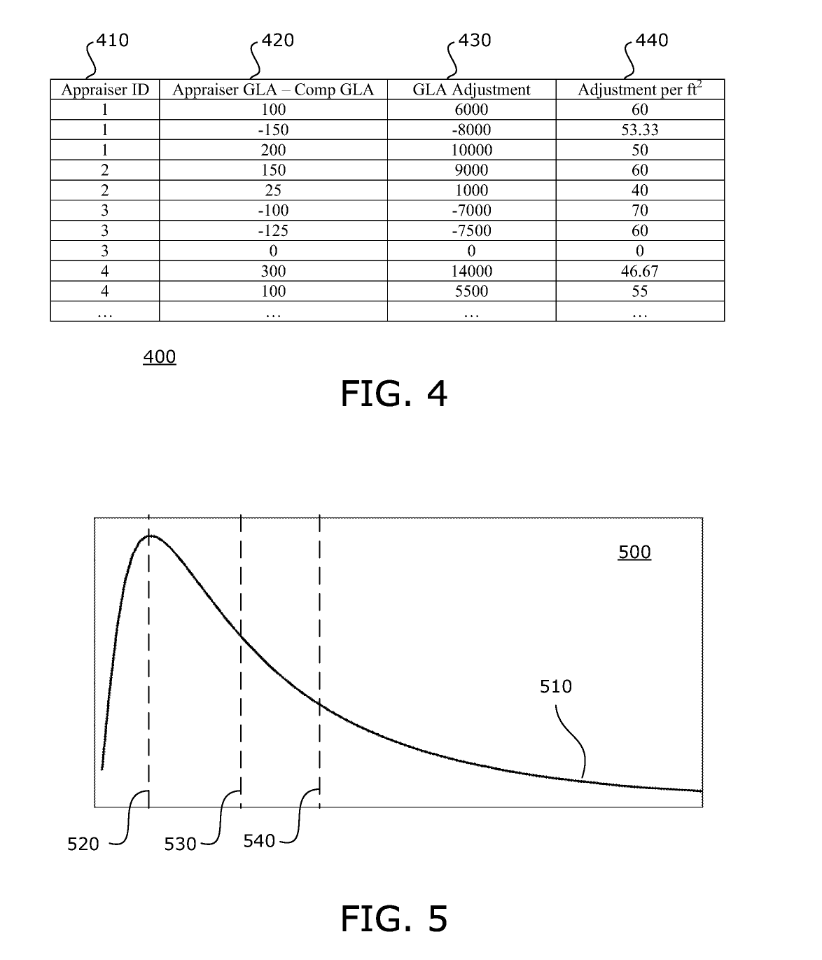

FIG. 4 is an example of a subset of a data table 400 for creating a statistical distribution according to various aspects. FIG. 4 includes an identifier column 410 corresponding to an appraiser ID, a differential column 420 corresponding to a difference between peer subject property characteristics and peer comp characteristics, an adjustment column 430 corresponding to a peer adjustment value, and a valuation column 440 corresponding to a peer valuation on the property characteristic. Entries in the valuation column 440 correspond to a peer adjustment value for a respective property characteristic.

In the illustrated example, the data table 400 contains columns corresponding to gross living area. The data table 400 may also include differential, adjustment, and valuation columns corresponding to one or more additional property characteristics in the same table. Alternatively, the peer adjustment database may include a separate data table for each property characteristic.

FIG. 5 is an example of a graph 500 illustrating a statistical distribution 510 (i.e., a peer adjustment distribution) of peer adjustment values for a given property characteristic; in this case, gross living area. In FIG. 5, the horizontal axis represents peer adjustment values, whereas the vertical axis represents the occurrence of each particular peer adjustment value, in arbitrary units. The peer adjustment value corresponding to dashed lines 520, 530, and 540 represent the mode, median, and mean of the statistical distribution, respectively.

In the illustrated example, the statistical distribution is a positively-skewed normal distribution. However, because the statistical distribution is based on actual data, it is not limited to any particular distribution.

### First Example

### Method

In a first example, appraisal adjustment scoring comprises operations that identify unreasonable adjustments and rates the overall quality of an appraiser's adjustments in a subject appraisal.

In the first example, the entire spectrum of adjustment errors and misrepresentations made by appraisers are examined by performing three unique evaluations of appraiser adjustments.

One such evaluation is a comparison of the adjustments made in a subject appraisal to those made by an automated valuation model. The computerized model may preferably be the model described above with reference to FIGS. 2-3.

A second such evaluation is a comparison of the adjustments made in the subject appraisal to those made in aggregate on other appraisals by appraiser peers who work in the same geographic location. The aggregate data may preferably be represented by the database described above with reference to FIGS. 4-5.

A third such evaluation is an examination of the composition of the comp pool chosen by the appraiser to determine the valuation impact of questionable or nonstandard adjustments on the appraiser's price opinion of the subject property.

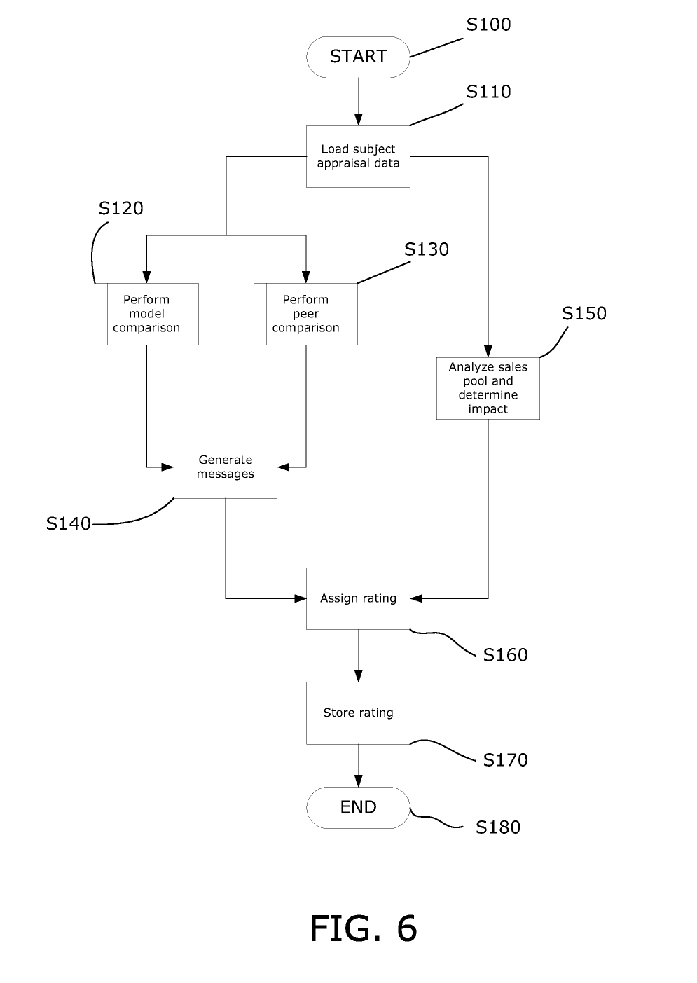

FIG. 6 is an example of a flowchart illustrating operations performed by the exemplary method. The operations illustrated may be performed for all property characteristics and associated adjustments in series, in parallel, or in a combination of series and parallel.

Where the operations illustrated in FIG. 6 are performed in series (that is, where each property characteristic is evaluated individually), all of steps S100-S180 may be performed for a first property characteristic or comp, then for a second property characteristic or comp, and so on. Alternatively, where the operations illustrated in FIG. 6 are performed in parallel (that is, where the appraisal is evaluated as a whole), each of steps S100-S180 may be performed for all property characteristics or comps before proceeding to the next step. In this manner, the exemplary method may selectively analyze (a) the appraiser's net or gross adjustment on a single comp compared to the model's net or gross adjustment on a single comp; and/or (b) the appraiser's adjusted prices for all comps on the appraisal compared to the model's adjusted prices for all comps on the appraisal.

The exemplary method is initialized at step S100. The exemplary method then proceeds to step S110 and loads the subject appraisal data. The data accessed in step S110 may correspond to a single property characteristic and associated adjustment, a subset of all property characteristics and associated adjustments, or all property characteristics and associated adjustments.

The exemplary method then performs the above unique evaluations in steps S120, S130, and S150 for the accessed data. Steps S120, S130, and S150 may be performed in series, in parallel, or in a combination of series and parallel. In step S120, the exemplary method performs a comparison between the appraiser adjustment value and a corresponding model adjustment value by performing a series of subprocesses described in more detail below. In step S130, the exemplary method performs a comparison between the appraiser adjustment value and a corresponding peer adjustment distribution by performing a series of subprocesses also described in more detail below. In step S150, the exemplary method performs an analysis of the chosen sales pool also described in more detail below.

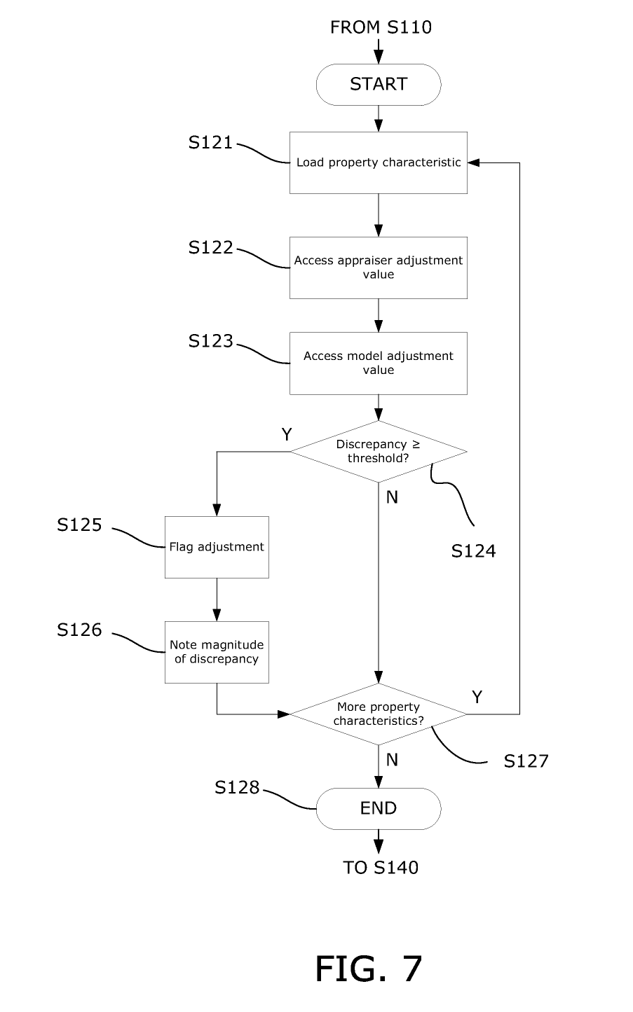

FIG. 7 is an example of a flowchart illustrating subprocesses performed in step S120 as shown with reference to FIG. 6. Although FIG. 7 shows the subprocesses being performed for all property characteristics in series, the subprocesses illustrated may instead be performed for all property characteristics and associated adjustments in parallel or in a combination of series and parallel.

The exemplary submethod is initialized at step S120 as shown with reference to FIG. 6. The exemplary submethod then proceeds to step S121 and loads a property characteristic identifier. In step S122, the exemplary submethod then accesses an appraiser adjustment value corresponding to the selected property characteristic. In step S123, the exemplary submethod then accesses a model adjustment value corresponding to the same selected property characteristic. In step S124, the exemplary submethod compares the appraiser adjustment value to the corresponding model adjustment value. When the magnitude of an appraiser-model discrepancy, which may be, for example, a percentage difference (or any other mathematical comparison) between the appraiser adjustment value and the model adjustment value, is greater than a first threshold, the exemplary submethod proceeds to steps S125 and S126. When the magnitude of the model discrepancy is less than the first threshold, the exemplary submethod proceeds directly to step S127. The first threshold may be either predetermined or dynamically calculated.

In step S125, the exemplary submethod flags the property characteristic identifier. In step S126, the exemplary submethod notes the magnitude of the appraiser-model discrepancy. Although FIG. 7 shows step S125 being performed before step S126, the order of steps S125 and S126 may be reversed. After both steps S125 and S126 have been completed, the exemplary submethod proceeds to step S127.

In step S127, the exemplary submethod determines if all desired property characteristics have been analyzed. If there are still more property characteristics to analyze, the exemplary submethod returns to step S121 and loads a new property characteristic identifier. If there are no additional property characteristics to analyze, the exemplary submethod is terminated in step S128, and the exemplary method proceeds to step S140 as shown in FIG. 6.

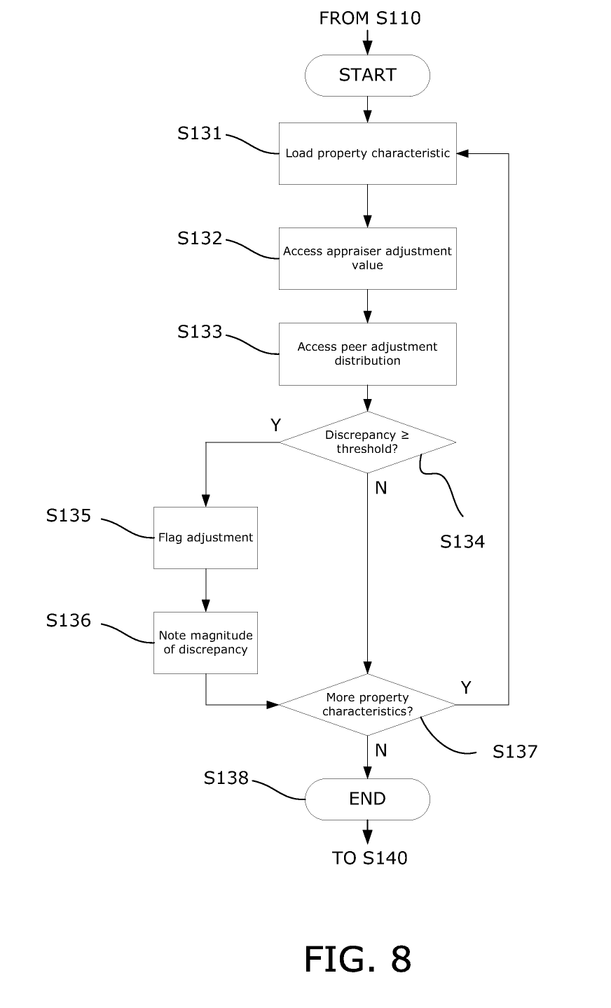

FIG. 8 is an example of a flowchart illustrating subprocesses performed in step S130 as shown with reference to FIG. 6. Although FIG. 8 shows the subprocesses being performed for all property characteristics in series, the subprocesses illustrated may instead be performed for all property characteristics and associated adjustments in parallel or in a combination of series and parallel.

The exemplary submethod is initialized at step S130 as shown with reference to FIG. 6. The exemplary submethod then proceeds to step S131 and loads a property characteristic identifier. In step S132, the exemplary submethod then accesses an appraiser adjustment value corresponding to the selected property characteristic. In step S133, the exemplary submethod then accesses a peer adjustment distribution corresponding to the same selected property characteristic. In step S134, the exemplary submethod compares the appraiser adjustment value to the corresponding peer adjustment distribution. When the magnitude of an appraiser-peer discrepancy, which may be, for example, a percentage difference (or any other mathematical comparison) between the appraiser adjustment value and a median of the peer adjustment distribution or the degree to which the appraiser adjustment value is outside of a particular probability interval based on the peer adjustment distribution, is greater than a second threshold, the exemplary submethod proceeds to steps S135 and S136. When the magnitude of the appraiser-peer discrepancy is less than the second threshold, the exemplary submethod proceeds directly to step S137. The second threshold may be either predetermined or dynamically calculated.

In step S135, the exemplary submethod flags the property characteristic identifier. In step S136, the exemplary submethod notes the magnitude of the discrepancy. Although FIG. 8 shows step S135 being performed before step S136, the order of steps S135 and S136 may be reversed. After both steps S135 and S136 have been completed, the exemplary submethod proceeds to step S137.

In step S137, the exemplary submethod determines if all desired property characteristics have been analyzed. If there are still more property characteristics to analyze, the exemplary submethod returns to step S131 and loads a new property characteristic identifier. If there are no additional property characteristics to analyze, the exemplary submethod is terminated in step S138, and the exemplary method proceeds to step S140 as shown in FIG. 6.

The exemplary submethods illustrated in FIGS. 7 and 8 may be performed in parallel. That is, upon performing steps S121 and S122, an exemplary combined submethod may perform all of steps S123-S126 and steps S133-S136 before proceeding to step S127 and determining whether all desired property characteristics have been analyzed.

In step S150 illustrated in FIG. 6, the exemplary method performs an analysis of the chosen sales pool. In performing this analysis, the exemplary method examines the composition of the comps in the sales pool chosen by the appraiser. The exemplary method then determines a valuation impact of the sales pool composition data on the respective appraiser adjustment value.

For example, if the exemplary method determines that all of the comps chosen by the appraiser are very similar to the subject property, the exemplary method may determine that any adjustment errors in the appraiser adjustment are likely to have small impact on the appraisal. On the other hand, if the exemplary method determines that some or all of the comps chosen by the appraiser are very dissimilar to the subject property, the exemplary method may flag the dissimilar comps and determine that any adjustment errors in the appraiser adjustment are likely to have a severe impact on the appraisal. In this manner, the exemplary method may detect situations where the comp pool is skewed to the superior (for example, larger GLA) side and the downward adjustments are inadequate, or where the comp pool is skewed to the inferior side and the upward adjustments are inadequate.

In step S140, the exemplary method determines if certain conditions have been met in steps S120, S130, and/or S150, and generates messages that indicate the adjustment dimension in question and the conditions that were violated. The conditions may be predetermined or dynamically calculated, and may vary according to associated property characteristics. Although FIG. 6 illustrates the messages being generated based on the output of steps S120 and/or S130, the messages may also or alternatively be generated based on the output of step S150.

For example, the exemplary method may generate a first message when comps skew large or small relative to the subject property and when the appraiser's GLA adjustment is an outlier compared to both peers and model for a particular property characteristic. In other words, the first message may indicate that the adjustment error is large compared to both the model adjustment and the peer adjustment, and that the adjustment error is likely to have a severe impact on the appraisal.

Furthermore, the exemplary method may generate a second message when the appraiser's net adjustment for a particular comp based on all relevant property characteristics differs from the net model adjustment by a particular amount; for example, by 20% or more. In other words, the second message may indicate that even if the adjustment error is small, any adjustment error is likely to have a disproportionately large impact on the appraisal.

Although only two messages have been explicitly described, the exemplary method may generate more than two different types of messages based on a given set of messaging rules. Furthermore, multiple messages may be generated for a single comp and/or a single property characteristic.

In step S160, the exemplary method assigns a single overall adjustment rating based upon the combination and severity of messages generated in step S140. The exemplary method may rate the appraiser's adjustments on an ordinal scale, for example from one to five. In this example, a lower rating score indicates no or few adjustment risks, and a higher rating score indicates increasingly significant problems that increase the risk of valuation misrepresentation. The exemplary method may calculate the rating based on a predetermined or dynamically calculated scoring table.

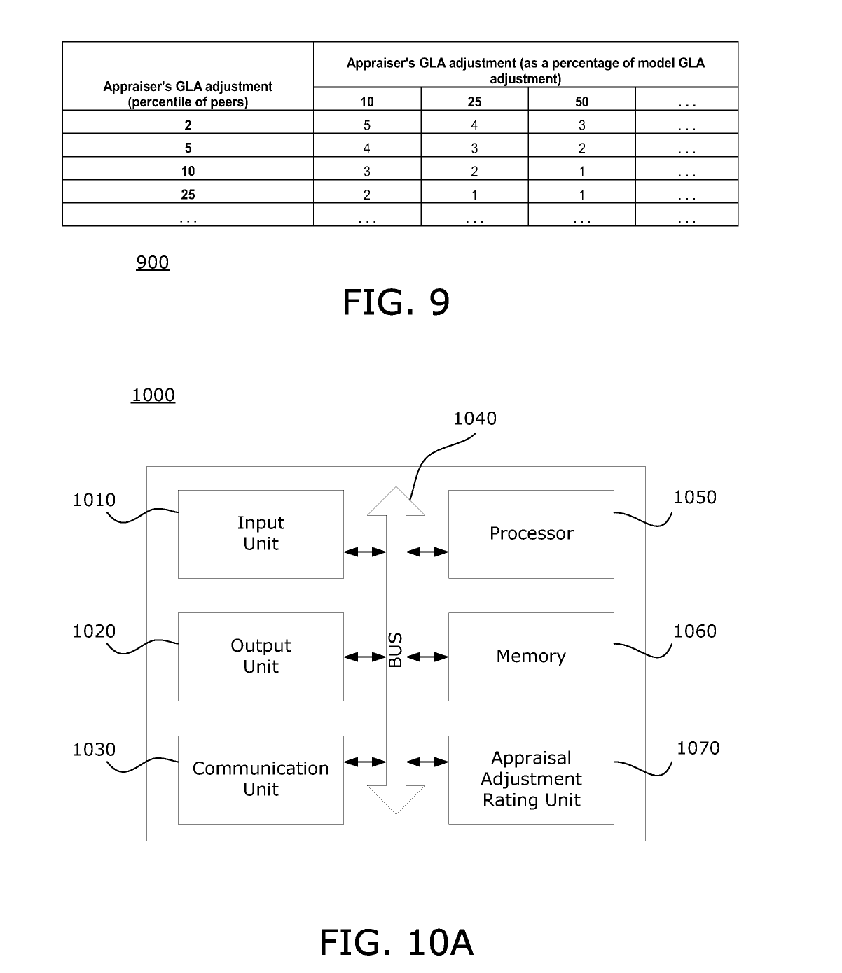

FIG. 9 shows an example of a scoring table 900 for use with various aspects of the present disclosure. Scoring table 900 refers only to adjustments based on gross living area as an example; however, the exemplary method may assign a rating based on more or different property characteristics as desired. In the exemplary method, every appraisal begins with a default score; for example, one (1) or zero (0), which may increase based on messages generated in step S140 shown in FIG. 6.

In an exemplary method using scoring table 900, a plurality of penalty points are assigned based on the degree of difference in the appraiser adjustment as compared with the model and peers. In this example, an appraisal adjustment that is in the second percentile compared with peers and is less than ten percent of the model adjustment receives five points. The amount of penalty points decreases as the adjustment as a percentile of peers and/or as a percentage of model becomes closer to the mean or median. In other words, larger deviations from the model in combination with an appraiser adjustment being farther out in the peer distribution tail will result in a larger penalty than a smaller deviation from the model combined with the appraiser adjustment being closer to the peer distribution mean or median. In this manner, the total amount of penalty points is indicative of both an appraiser-peer discrepancy and an appraiser-model discrepancy.

While one exemplary scoring table 900 has been provided for illustration, in practice any particular scoring method may be utilized so long as the scoring method quantifies the concepts wherein: (a) larger deviations from peers and model jointly will result in larger penalties for each individual adjustment; (b) the appraised value of the subject property is deemed less reliable the more individual adjustments are flagged by the exemplary method; and (c) bad adjustments made on a comp pool that is heavily skewed to one side of the subject property are deemed more likely to have a material impact on the overall appraised value of the subject property.

After step S160 has been completed, the exemplary method proceeds to step S170 as illustrated in FIG. 6. In step S170, the exemplary method stores the rating assigned in step S160 along with any messages generated in step S150. Step S170 may comprise storing the rating and messages in a local memory or transmitting the rating and messages for remote storage. Furthermore, step S170 may comprise storing the rating and messages in local memory and transmitting the rating and messages on demand to other associated systems.

After step S170 has been completed, the exemplary method may terminate at step S180. In other aspects, the exemplary method may proceed from step S180 back to step S100 to repeat steps S110-S170 for one or a plurality of additional property characteristics.

### Second Example

### Device

In a second example, appraisal adjustments scoring comprises a computing device that identifies unreasonable adjustments and rates the overall quality of an appraiser's adjustments in a subject appraisal.

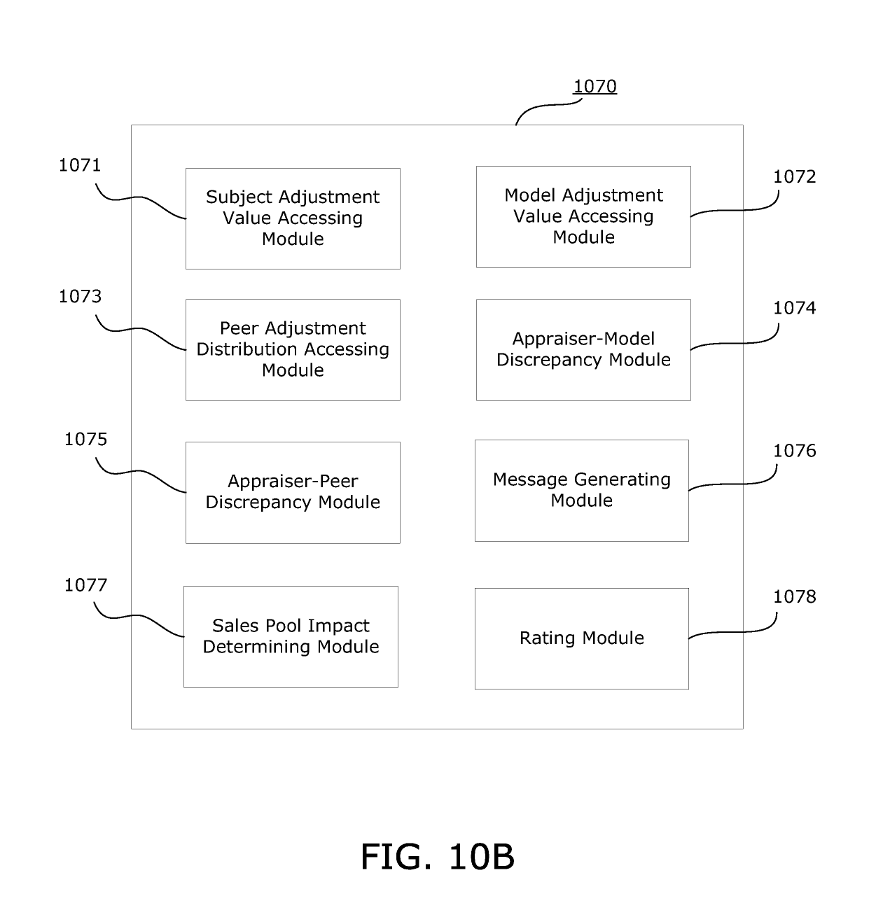

FIG. 10A is an example of a computing device 1000 configured to perform operations comprising, for example, the operations described above. The computing device 1000 includes an input unit 1010, an output unit 1020, a communication unit 1030, a processor 1050, a memory 1060, and an appraisal adjustment rating unit. Individual units may be interconnected by a bus 1040. The bus 1040 may comprise a wired or wireless connection. The computing device 1000 may be, for example, a personal computer, laptop computer, tablet device, smartphone, personal digital assistant, or the like. Although FIG. 10A shows the appraisal adjustment rating unit 1070 as a separate unit, the computing device 1000 is not so limited. For example, the memory 1060 may include a non-transitory computer readable medium including the appraisal adjustment rating unit 1070. Alternatively, the computing device 1000 may include an external computer program product, such as a CD-ROM, DVD-ROM, flash drive, or remote server, storing the appraisal adjustment rating 1070.

FIG. 10B is an example of appraisal adjustment rating unit 1070. The exemplary appraisal adjustment unit includes an appraiser adjustment value accessing module 1071, a model adjustment value accessing module 1072, a peer adjustment distribution accessing module 1073, an appraiser-model discrepancy module 1074, an appraiser-peer discrepancy module 1075, a message generating module 1076, a sales pool impact determining module 1077, and a rating module 1078.

The appraiser adjustment value accessing module 1071 may be configured to access an appraiser adjustment value corresponding to a value of a respective property characteristic of a subject property as determined by an appraiser of the subject property. The model adjustment value accessing module 1072 may be configured to access a model adjustment value corresponding to an expected value of the respective property characteristic as determined by an automated valuation module. The peer adjustment distribution accessing module 1073 may be configured to access a peer adjustment distribution corresponding to an aggregate value of the respective property characteristic as determined by appraiser peers. The appraiser adjustment value, model adjustment value, and peer adjustment distribution may be located in a database. Alternatively, the appraiser adjustment value, model adjustment value, and peer adjustment distribution may be located in separate databases.

The appraiser-model discrepancy module 1074 may be configured to determine an appraiser-model discrepancy when a difference between the appraiser adjustment value and the model adjustment value exceeds a first threshold. The appraiser-peer discrepancy module 1075 may be configured to determine an appraiser-peer discrepancy when the difference between the appraiser adjustment value and the peer adjustment distribution exceeds a second threshold.

The appraiser-model discrepancy module 1074 and the appraiser-peer discrepancy module 1075 may be configured to perform operations in parallel; for example, as shown in FIG. 6. In this configuration, both an appraiser-model discrepancy and an appraiser-peer discrepancy are simultaneously calculated. Alternatively, the appraiser-model discrepancy module 1074 and the appraiser-peer discrepancy module 1075 may be configured to perform operations in series. In this alternate configuration, the appraiser-peer discrepancy module may be bypassed if the appraiser-model discrepancy is below a threshold value, or vice versa.

The message generating module 1076 may be configured to generate a respective adjustment message when a condition is met during the steps of determining, the adjustment message indicating the respective property characteristic and the condition.

The sales pool impact determining module 1077 may be configured to access a sales pool composition data corresponding to comparable sales as determined by the appraiser. The sale spool impact determining module 1077 may be further configured to determine a valuation impact of the sales pool composition data on the respective appraiser adjustment value.

The rating module 1078 may be configured to assign a rating to the property appraisal, the rating being based upon the number and severity of the adjustment messages and the valuation impact.

The databases described above may be stored in the memory 1060, in the external computer program product, or in a remote device, and may be accessed by the computing device 1000 via the internal bus 1040 or via the communication unit 1030 connected to, for example, a network.

### Third Example

### System

In a third example, appraisal adjustments scoring comprises a computer system that identifies unreasonable adjustments and rates the overall quality of an appraiser's adjustments in a subject appraisal.

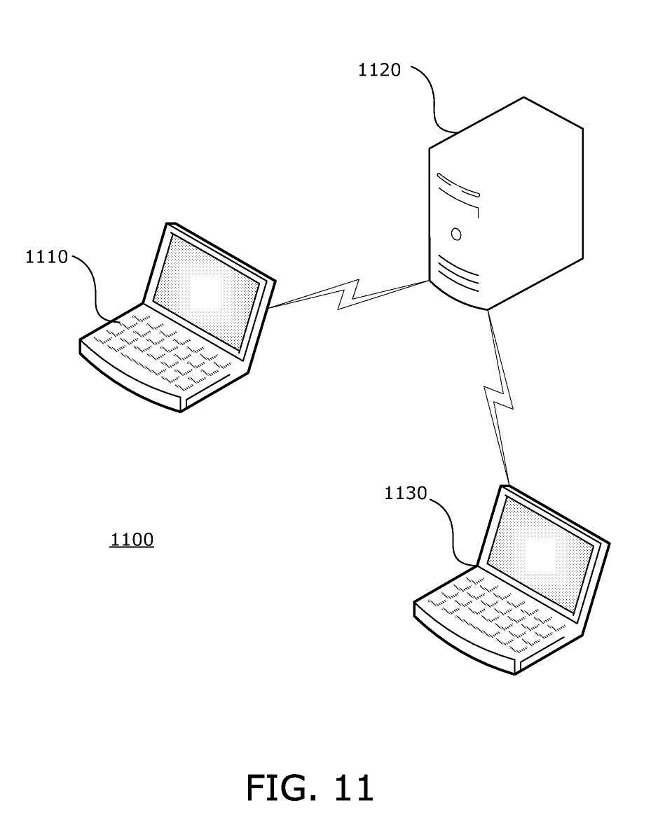

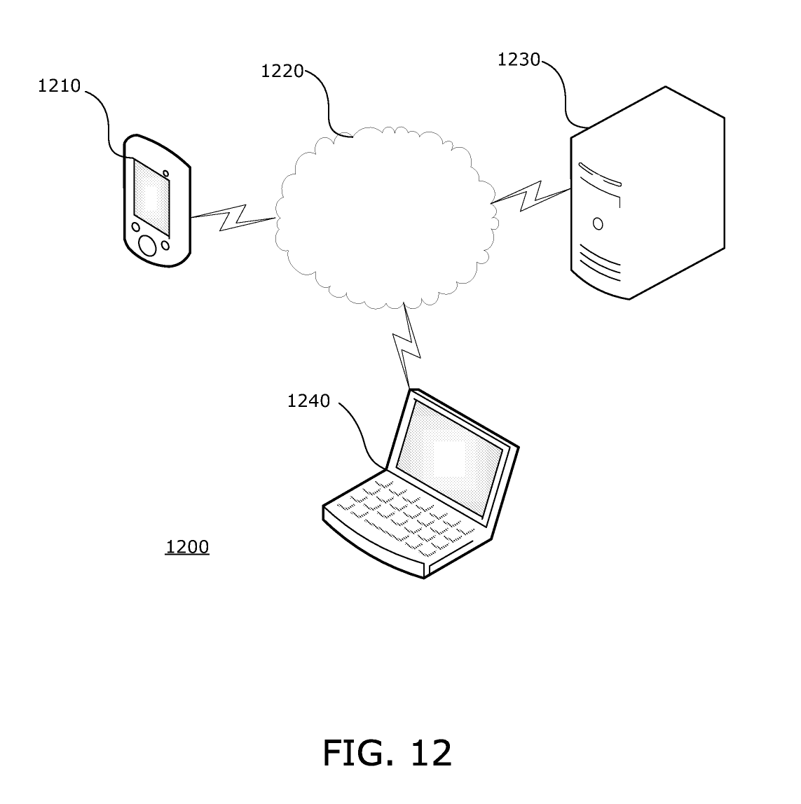

FIG. 11 is an example of a system 1100 comprising one or more terminal computing devices 1110, 1130 connected to a server computing device 1120. The computing devices 1110-1130 may each be configured similarly to the above-described computing device 1000. The system 1100 may comprise operations as described above. Although the illustrated example shows one server and two terminals, the system may comprise more or fewer servers and/or terminals as desired.

The operations may be stored entirely in a memory of one of the computing devices 1110-1130, for example the server computing device 1120. In such a configuration, the operations may be accessed by terminal computing devices 1110, 1130 via the network connection. Thereby, the terminal computing devices 1110, 1130 may execute the operations by accessing the program code stored on the server computing device 1120.

Alternatively, the operations may be stored in a distributed manner across more than one computing device 1110-1130. In such a configuration, portions of the operations may be accessed by terminal computing devices 1110, 1130 via a network connection and other portions of the operations may be accessed by terminal computing devices 1110, 1130 from their respective internal memories. Thereby, a user may execute a user interface portion of the operations via a terminal computing device 1110, causing the terminal computing device 1110 to communicate with the server computing device 1120. In response, the server computing device 1120 may execute appropriate portions of the operations and communicate data generated therein to the terminal computing device 1110 for storage, display, or further analysis. In an alternate configuration, respective portions of the operations may be performed by a plurality of computing devices in a distributed manner, for example by distributed parallel computing.

Although the example of FIG. 11 illustrates the computing devices 1110-1130 being connected via a private network such as a local area network (LAN), the system is not so limited. For example, FIG. 15 illustrates a system 1200 wherein computing devices 1210, 1240, 1230 are connected to one another via an intermediate network 1220, such as the Internet. In this example, server computing device 1230 may comprise a web server that hosts a webpage including data generated from operations executed by the server computing device 1230, and users of terminal computing devices 1210, 1240 may view the data generated from the operations by opening the webpage on the respective terminal computing devices 1210, 1240.

Computing devices such as the computing devices 1000, 1110-1130, 1210, and 1230-1240 may generally include computer-executable instructions such as the instructions to perform the operations, where the instructions may be executable by one or more computing devices such as those listed above. Computer-executable instructions may be compiled or interpreted from computing programs created using a variety of programming languages and/or technologies, including but not limited to Java™, C, C++, FORTRAN, Visual Basic, PERL, etc., and combinations thereof. Generally, a processor, for example, a microprocessor, receives instructions from, for example, a memory, a computer-readable medium, etc., and executes these instructions, thereby performing one or more processes, including one or more of the processes or subprocesses described herein. Such instructions and other data may be stored and transmitted using a variety of computer-readable media.

It is understood that as used herein, a processor may “perform” or “execute” a particular function by issuing the appropriate commands to other units, such as other components of the computing device, peripheral devices linked to the computing device, or other computing devices. As such, the commands may cause other units to take certain actions related to the function. For example, although a processor does not display an image in the sense of the processor itself physically emitting light in a pattern, the processor may nonetheless “execute” the function of “displaying” an image by issuing the appropriate commands to a display device that would then emit light in the requisite pattern. In this example, the display device that the processor causes to display the image may be part of the computing device that includes the processor, or may be connected remotely to the computing device that includes the processor by way of, for example, a network. In this manner, a processor included in a server hosting a webpage may “display” an image by issuing commands via the Internet to a remote computing device, the commands being such as would cause the remote computing device to display the image. Moreover, for the processor to have “executed” the particular function, the generation of a command that would cause another unit to perform the various actions of the function is sufficient, whether or not the other unit actually completes the actions.

A computer-readable medium described herein includes any non-transitory (tangible) medium that participates in providing data, such as instructions, that may be read by a computer. Such a medium may take a variety of forms, including but not limited to volatile media such as random access memory (RAM) or non-volatile media such as optical or magnetic disks. Such instructions may be transmitted via one or more transmission media, including coaxial cables, copper wire, and fiber optics, including the wires that comprise a system bus coupled to a processor of a computer. Common forms of computer-readable media include, for example, a floppy disk, a hard disk, magnetic tape, a CD-ROM, a DVD-ROM, punch cards, paper tape, RAM, flash memory, or any other medium from which a computer can read.

Databases, data repositories, data tables, or other data stores described herein may include various kinds of mechanisms for storing, accessing, and retrieving various kinds of data, including a hierarchical database, a set of files in a system, an application database in a proprietary format, a relational database management system (RDBMS), etc., or combinations thereof. Each such data store is typically included within a computing device employing a computer operating system such as those mentioned above, and are accessed via a network in a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

### CONCLUSION

The automation of adjustment scoring is a new step in appraisal evaluation that has never been accomplished before at this level of detail and with this comprehensive a database of appraisal data. The rating operations, based on messaging, allows for a level of granularity previously unseen in appraisal evaluation and analysis. Furthermore, by evaluating an appraisal in comparison both to a model and to peers while simultaneously evaluating the composition of the pool of comparable sales, various embodiments accurately identify only those adjustments most likely to impact value.

With regard to the processes, systems, methods, submethods, algorithms, operations, etc., described herein, it should be understood that, although the steps of such operations have been described as occurring in a certain ordered sequence, such operations could be practiced with the described steps performed in an order other than the order described herein. It further should be understood that certain steps may be performed simultaneously, that other steps could be added, or that certain steps described herein could be omitted. In other words, the descriptions of operations herein are provided for the purpose of illustrating certain aspects of the application, and should not be construed so as to limit the scope of the application.

Accordingly, it is to be understood that the above description is intended to be illustrative and not restrictive or exhaustive. Although various aspects been described in considerable detail with reference to certain aspects thereof, the invention may be variously embodied without departing from the spirit or the scope of the invention. Therefore, many aspects and applications other than the specific examples provided herein would be apparent upon reading of the above description. It is anticipated and intended that future developments will occur in the technologies discussed herein, and that the disclosed systems and methods will be incorporated into such future embodiments. In other words, it should be understood that the application is capable of modification and variation.

1. A method of evaluating a property appraisal comprising:
accessing, by a processing unit, an appraiser adjustment value corresponding to a value of a respective property characteristic of a subject property as determined by an appraiser of the subject property;
accessing, by the processing unit, a model adjustment value corresponding to an expected value of the respective property characteristic of the subject property as determined by an automated valuation model;
accessing at least one peer adjustment distribution corresponding to an aggregate of the respective property characteristic of the subject property as determined by appraiser peers in the same geographic location as the subject property;
determining, by the processing unit, an appraiser-model discrepancy when a difference between the appraiser adjustment value and the model adjustment value exceeds a first threshold; and
determining, by the processing unit, an appraiser-peer discrepancy when a difference between the appraiser adjustment value and the peer adjustment distribution exceeds a second threshold.

2. The method according to claim 1, further comprising:
generating a respective adjustment message when a condition is met during the steps of determining, the adjustment message indicating the respective property characteristic and the condition.

3. The method according to claim 2, further comprising:
accessing a sales pool composition data, the sales pool composition data corresponding to comparable sales as determined by the appraiser; and
determining a valuation impact of the sales pool composition data on the respective appraiser adjustment value.

4. The method according to claim 3, further comprising assigning a rating to the property appraisal, the rating being based upon the number and severity of adjustment messages and the valuation impact.

5. The method according to claim 4, further comprising storing the adjustment messages and/or the rating in a memory.

6. The method according to claim 4, further comprising transmitting the adjustment messages and/or the rating to a remote system.

7. The method according to claim 2, wherein the condition is predetermined.

8. The method according to claim 2, wherein the condition is dynamically calculated.

9. The method according to claim 1, wherein the automated valuation model is a regression model.

10. The method according to claim 9, wherein the automated valuation model is a hedonic regression model.

11. The method according to claim 1, further comprising repeating the steps of accessing and determining for a plurality of property characteristics.

12. The method according to claim 11, wherein the plurality of property characteristics are selected from the group including proximity to subject, sale price, sale price per gross living area, financing concessions, date of sale, location, sale type, lot size, view, style, quality of construction, actual age, condition, above grade room count, gross living area, finished rooms below grade, functional utility, HVAC, energy efficient items, garage, patio, fireplace

13. The method according to claim 11, wherein the plurality of property characteristics are representative of a rental income potential of the property.

14. The method according to claim 11, wherein the plurality of property characteristics are representative of a cost to build an equivalent property.

15. A computer program product comprising a non-transitory computer readable medium having program code stored thereon, the program code being executable by a processor to perform operations comprising:
accessing, by a processing unit, an appraiser adjustment value corresponding to a value of a respective property characteristic of a subject property as determined by an appraiser of the subject property;
accessing, by the processing unit, a model adjustment value corresponding to an expected value of the respective property characteristic of the subject property as determined by an automated valuation model;
accessing at least one peer adjustment distribution corresponding to an aggregate of the respective property characteristic of the subject property as determined by appraiser peers in the same geographic location as the subject property;
determining, by the processing unit, an appraiser-model discrepancy when a difference between the appraiser adjustment value and the model adjustment value exceeds a first threshold; and
determining, by the processing unit, an appraiser-peer discrepancy when a difference between the appraiser adjustment value and the peer adjustment distribution exceeds a second threshold.

16. A computing device comprising:
at least one processor; and
a memory unit, the memory unit having stored thereon program code executable by the at least one processor to perform operations comprising:
accessing, by a processing unit, an appraiser adjustment value corresponding to a value of a respective property characteristic of a subject property as determined by an appraiser of the subject property;
accessing, by the processing unit, a model adjustment value corresponding to an expected value of the respective property characteristic of the subject property as determined by an automated valuation model;
accessing at least one peer adjustment distribution corresponding to an aggregate of the respective property characteristic of the subject property as determined by appraiser peers in the same geographic location as the subject property;
determining, by the processing unit, an appraiser-model discrepancy when a difference between the appraiser adjustment value and the model adjustment value exceeds a first threshold; and
determining, by the processing unit, an appraiser-peer discrepancy when a difference between the appraiser adjustment value and the peer adjustment distribution exceeds a second threshold.
